(19) United States
(12) Patent Application Publication
(10) Pub. No.: US 2015/0381084 A1
(43) Pub. Date: Dec. 31, 2015

(54) Method and Device for Operating an On-Board Power System

(71) Applicant: Bayerische Motoren Werke Aktiengesellschaft, Muenchen (DE)

(72) Inventors: Daniel FINDEISEN, Erding (DE); Joerg REUSS, Unterschleissheim (DE); Matthias GORKA, Munich (DE); Michael STEINBERGER, Koefering (DE)

(21) Appl. No.: 14/848,760

(22) Filed: Sep. 9, 2015

Related U.S. Application Data
(63) Continuation of application No. PCT/EP2014/054778, filed on Mar. 12, 2014.

(30) Foreign Application Priority Data
Mar. 12, 2013 (DE) 10 2013 204 255.8

(51) Int. Cl. H02P 6/00

(52) U.S. Cl. CPC H02P 6/002

(57) ABSTRACT

An on-board power system has a three-phase motor having a first and at least a second at least three-phase winding, a first and a second electric component energy on-board power system, as well as a first and a second actuator element, which are each electrically connected to one of the windings and one of the electric component energy on-board power systems. In order to transfer energy between the first and second electric component energy on-board power systems, the first actuator is actuated to generate a voltage in the first at least three-phase winding, such that a voltage is induced in the second at least three-phase winding, a result of which is to transfer energy between the first and the second partial-energy on-board power system, and wherein the generated voltage in the first at least three-phase winding is an AC voltage with voltage vectors oriented to contribute to the fact that substantially no torque is generated in the rotor by the voltage generated for the energy transfer in the first winding.

### CROSS REFERENCE TO RELATED APPLICATIONS

This application is a continuation of PCT International Application No. PCT/EP2014/054778, filed Mar. 12, 2014, which claims priority under 35 U.S.C. §119 from German Patent Application No. 10 2013 204 255.8, filed Mar. 12, 2013, the entire disclosures of which are herein expressly incorporated by reference.

### BACKGROUND AND SUMMARY OF THE INVENTION

The invention relates firstly to a method and device for operating an on-board power system comprising a three-phase motor.

On-board power systems in modern vehicles often have a plurality of on-board power system voltages such as, for example, a conventional 12 volt voltage for standard consumers and/or a further 12 volt voltage for decoupling the voltage dip during starting of an internal combustion engine from the rest of the on-board power system, for example, and/or a higher voltage for functions such as increased recuperation or for supplying high-power consumers, for example. For this purpose, two or more partial-energy on-board power systems are used which are decoupled from one another and are coupled via a DC-to-DC converter, for example, in order to ensure an average state of charge of the partial-energy on-board power systems.

DE 10 2005 044 341 A1 discloses an electric generator which contains a rotor, a stator, a rectifier and a regulator. The rotor contains a field winding. The stator contains a first and a second three-phase winding, each of which has three output connections corresponding to the respective phases. The rectifier has a three-layer structure, to which the output connections of the first and second three-phase windings are connected separately, and operates in such a way as to output two different DC voltages by rectification of the output variables of the two three-phase windings.

DE 10 2005 026 779 A1 discloses an electrical drive device, comprising a polyphase electric machine, a plurality of electrical power outputs stages and means connected to the electrical power output stages for controlling and/or regulating the electric machine, wherein at least two means for control and/or regulation are provided, wherein each means is assigned to at least one power output stage group.

U.S. Pat. No. 6,617,820 B2 discloses a method for generating a low auxiliary voltage for electric or hybrid vehicles by means of tapping off a voltage of a first winding of a traction motor with a second winding and a rectifier.

An object of the invention is to provide a method and a device for operating an on-board power system, which method or device contributes to enabling energy transfer between a first and at least a second electrical partial-energy on-board power system without galvanic coupling.

The object is achieved by the features of the independent patent claims. Advantageous configurations are characterized in the dependent claims.

The invention is characterized firstly by a method for operating an on-board power system and secondly by a corresponding device for operating an on-board power system. The on-board power system has a three-phase motor, which has a stator and a rotor, wherein the stator has a first at least three-phase winding and at least a second at least three-phase winding, which are inductively coupled to one another. Furthermore, the on-board power system has a first and at least a second electrical partial-energy on-board power system. Furthermore, the on-board power system has a first actuator, which is electrically connected to the first winding and the first electrical partial-energy on-board power system. Furthermore, the on-board power system has at least a second actuator, which is electrically connected to the second winding and at least the second electrical partial-energy on-board power system. For energy transfer between the first and at least the second electrical partial-energy on-board power system, the first actuator is actuated in such a way that a voltage is generated on the first winding by means of the first actuator, by means of which voltage a voltage is induced in the second winding, as a result of which energy is transferred between the first and at least the second electrical partial-energy on-board power system. In this case, the generated voltage in the first winding is an AC voltage whose voltage vectors are oriented in such a way that substantially no torque is generated in the rotor by the voltage generated for the energy transfer in the first winding.

The on-board power system is in particular a multiple-voltage on-board power system, in particular in a vehicle. A partial-energy on-board power system can have one or more energy stores and/or one or more energy sources and/or one or more consumers. The first and second partial-energy on-board power systems can in this case have one or more energy stores and/or consumers and/or energy sources of the same or different types. Such energy stores are, of example, a lead-acid rechargeable battery and/or a lithium-ion rechargeable battery and/or a double-layer capacitor. Such energy sources are fuel cells, for example. Such consumers can be powerful electric fans, for example.

In this way, energy can be transferred from the first electrical partial-energy on-board power system into the second electrical partial-energy on-board power system and/or into further electrical partial-energy on-board power systems without there being any galvanic coupling between the partial-energy on-board power systems. Furthermore, no additional component parts are required, as a result of which very favorable energy transfer can be realized.

The generated voltage in the first winding is in this case an AC voltage whose voltage vectors are oriented in such a way that substantially no torque, in particular no torque, is generated in the rotor by the voltage generated for energy transfer in the first winding. In this context, substantially means that if the motor is at a standstill, the rotor does not perform any significant movements, but only extremely small rotational movements such as through +/−30°, for example. If the rotor is in motion, this means in this context that, owing to the voltage generated in the first winding, for example considering a rotor revolution, no or only a very low torque, such as, for example +/−5% of a rated torque, possibly in addition to a setpoint torque, is generated in the rotor. Thus, the energy transfer can be realized when the rotor is at a standstill and when the rotor is rotating. It is thus possible to prevent the vehicle from moving in an undesired manner during the energy transfer, for example if the three-phase motor is coupled to the drive of the vehicle. By virtue of an AC voltage being generated, in addition the inertia of the rotor can be used. The frequency of the AC voltage is selected, for example, such that the inertia of the rotor results in said rotor generating substantially no torque, in particular no torque, owing to the energy transfer.

In accordance with an advantageous configuration, the voltage vectors of the generated voltage are oriented in such a way that they are substantially perpendicular to a magnetic flux density of a magnetic excitation of the rotor. In this way, the orientation of the rotor can additionally advantageously be used for the energy transfer.

The axis on which the voltage vectors substantially lie, in particular lie, can also be referred to as the q axis. This axis describes the torque to be generated of the rotor. The axis of the magnetic flux density can also be referred to as the d axis.

In accordance with an advantageous configuration, the voltage vectors of the generated voltage are oriented in such a way that they are substantially parallel to a magnetic flux density of a magnetic excitation of the rotor.

By virtue of the voltage vectors of the generated voltage being oriented in such a way that they are substantially parallel, in particular parallel, to a magnetic flux density of a magnetic excitation of the rotor, in addition the orientation of the rotor can be used advantageously for the energy transfer.

In accordance with an advantageous configuration, the first actuator has a circuit arrangement, wherein the circuit arrangement has in each case at least three element groups, which are connected in parallel. The element groups each have at least two individual elements, which are connected in series. The individual elements each have a switching element and a diode connected in parallel. The first winding is electrically connected to the circuit arrangement in such a way that in each case one element group of the circuit arrangement is electrically connected between the individual elements to a phase of the first winding.

As a result, the first actuator can be realized in a simple and inexpensive manner.

In accordance with a further advantageous configuration, for the energy transfer between the second and at least the first partial-energy on-board power system, the second actuator is actuated in such a way that a voltage is generated in the second winding by means of the second actuator, by means of which voltage a voltage is induced in the first winding, as a result of which energy is transferred between the second and at least the first electrical partial-energy on-board system. The generated voltage in the second winding is in this case an AC voltage, whose voltage vectors are oriented in such a way that substantially no torque is generated in the rotor as a result of the voltage generated for the energy transfer in the second winding.

In this way, energy transfer both from the first electrical partial-energy on-board power system to the second electrical partial-energy on-board power system and from the second electrical partial-energy on-board power system to the first electrical partial-energy on-board power system is possible and/or into further partial-energy on-board power systems.

The voltage vectors of the voltage generated in the second winding are oriented, for example, in such a way that they are perpendicular and/or parallel to the magnetic flux density of the magnetic excitation of the rotor. In this way, in addition the orientation of the rotor can be used advantageously for the energy transfer.

In accordance with a further advantageous configuration, the second actuator has a circuit arrangement, wherein the circuit arrangement has in each case at least three element groups, which are connected in parallel and which each have at least two individual elements, which are connected in series. The individual elements in this case each have a switching element and a diode connected in parallel. The second winding is electrically connected to the circuit arrangement in such a way that in each case one element group of the circuit arrangement is electrically connected between the individual elements to a phase of the second winding.

As a result, the second actuator can be realized in a simple and inexpensive manner.

Exemplary embodiments of the invention are explained in more detail below with reference to the schematic drawing, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an on-board power system comprising a three-phase motor, a first and a second electrical partial-energy on-board power system and a first and a second actuator.

### DETAILED DESCRIPTION OF THE DRAWINGS

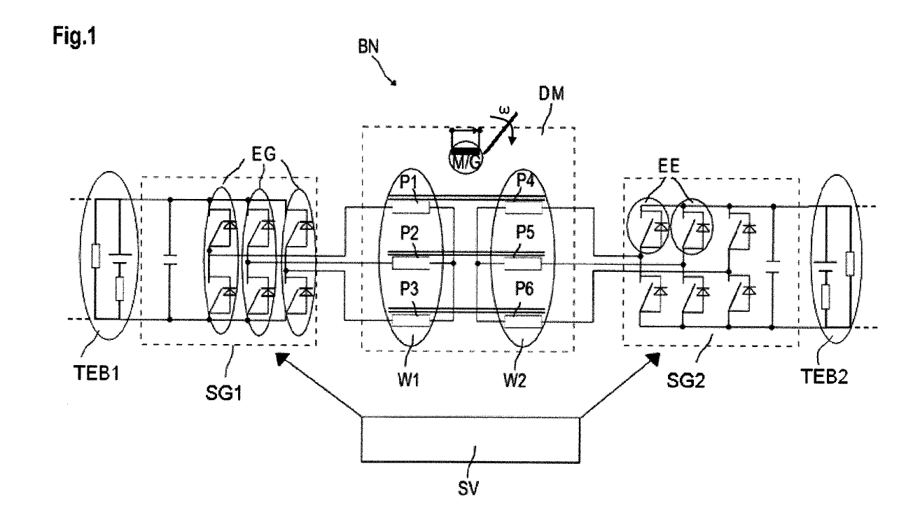

FIG. 1 shows an on-board power system BN. The on-board power system BN is in particular a multiple-voltage on-board power system of a vehicle. The on-board power system BN has a three-phase motor DM. the three-phase motor DM has a stator and a rotor. A separately excited three-phase motor DM in the form of a synchronous machine is shown in FIG. 1. Alternatively, other types of three-phase motors DM can also be used, such as, for example, asynchronous machines and/or a separately excited or permanent magnet, or a combination of a separately excited and a permanent magnet, synchronous machine or asynchronous machine.

The stator of the three-phase motor DM has a first winding W1 comprising at least three phases P1, P2, P3 and at least a second winding W2 comprising at least three phases P4, P5, P6. The windings W1, W2 shown in FIG. 1 are star windings, but one of the two windings W1, W2 or both windings W1, W2 can also alternatively be delta windings or else all other possible types of windings. Instead of three-phase windings W1, W2 windings W1, W2 with in each case more than three phases can also be used.

The first three-phase winding W1 is inductively coupled to the second three-phase winding W2. The first winding W1 is electrically connected to a first actuator SG1.

The first actuator SG1 has a circuit arrangement, such as, for example, a so-called B6 bridge circuit, which has in each case three element groups EG, which are connected in parallel. The element groups EG each have two individual elements EE, which are connected in series. The individual elements EE each have a switching element and a diode connected in parallel. The first winding W1 is electrically connected to the circuit arrangement in such a way that in each case one element group EG of the circuit arrangement is electrically connected between the individual elements EE to a phase P1, P2, P3 of the first winding W1.

The second winding W2 is electrically connected to a second actuator SG2. The second actuator SG2 has a circuit arrangement, such as a so-called B6 bridge circuit, for example, which has in each case three element groups EG, which are connected in parallel. The element groups EG each have two individual elements EE, which are connected in series. The individual elements EE each have a switching element and a diode connected in parallel. The second winding W2 is electrically connected to the circuit arrangement in such a way that in each case one element group EG of the circuit arrangement is electrically connected between the individual elements EE to a phase P4, P5, P6 of the second winding W2.

The first actuator SG1 and/or the second actuator SG2 and/or further actuators can alternatively also be in the form of multilevel converters.

The first actuator SG1 is electrically connected to a first electrical partial-energy on-board power system TEB1. The second actuator SG2 is electrically connected to a second electrical partial-energy on-board power system TEB2. The first and second partial-energy on-board power systems TEB1, TEB2 can be partial-energy on-board power systems of different types, but alternatively they can also be partial-energy on-board power supply systems of the same type. Such partial-energy on-board power supply systems TEB1, TEB2 have, for example, one or more energy stores and/or consumers and/or energy sources of the same or different types. Such energy stores are a lead-acid rechargeable battery and/or a lithium-iron rechargeable battery and/or a double-layer capacitor, for example. Such energy sources are fuel cells, for example. Such consumers can be powerful electric fans, for example.

The first and second partial-energy on-board power systems TEB1, TEB2 can have the same or different rated voltages, for example, such as 12V, 24V, 48V or other rated voltages, for example, or else rated voltages of over 60V.

The first actuator SG1 and the second actuator SG2 additionally optionally each have a capacitor, connected in parallel with the circuit arrangement, for buffer-storing radiofrequency currents and/or for smoothing an output voltage.

The on-board power system BN furthermore has a control device SV. The control device SV comprises an arithmetic logic unit, a data and program store and an interface to which it is coupled for signaling, for controlling the switching elements of the first actuator SG1 and/or the second actuator SG2.

The control device SV can also be referred to as a device for operating an on-board power system.

Energy transfer between the first and second electrical partial-energy on-board power systems TEB1, TEB2 is described below. In the same way, by suitable actuation of the second actuator SG2, energy transfer between the second and first electrical partial-energy on-board power systems TEB2, TEB1 is possible and/or into a further or a plurality of further partial-energy on-board power systems is possible and/or by suitable actuation of a further actuator, energy transfer between the further actuator and the first electrical partial-energy on-board power system TEB1 and/or the second electrical partial-energy on-board power system TEB2 and/or further partial-energy on-board power systems.

The first actuator SG1 is actuated in such a way that a voltage is generated in the first winding W1 by means of the first actuator SG1, by means of which voltage a voltage is induced in the second winding W2, as a result of which energy is transferred between the first and at least the second partial-energy on-board power system TEB1, TEB2, wherein the generated voltage in the first winding W1 is an AC voltage, whose voltage vectors are oriented in such a way that they contribute to the fact that substantially no torque is generated in the rotor by the voltage generated for the energy transfer in the first winding W1.

The generated voltage is in this case an AC voltage whose voltage vectors are oriented in such a way that they contribute to the fact that substantially no torque, in particular no torque, is generated in the rotor by the voltage generated for the energy transfer in the first winding W1. The generation of the AC voltage in this case takes place by a suitable actuation of the switching elements of the first actuator SG1. The voltage vectors of the generated voltage are oriented, for example, in such a way that they are perpendicular to a magnetic flux density of a magnetic excitation of the rotor.

As an alternative or in addition, the voltage vectors can also be oriented in such a way that they are parallel to the magnetic flux density of the magnetic excitation of the rotor. The axis of the magnetic flux density of the excitation of the rotor can also be referred to as the d axis. The axis perpendicular to the d axis, which describes the torque to be generated of the rotor, can also be referred to as the q axis. The frequency of the generated AC voltage is set, for example, in such a way that the inertia of the rotor is used such that, owing to the voltage generated for the energy transfer in the first winding W1, substantially no torque, in particular no torque, is generated. In this context, substantially means that if the motor is at a standstill, the rotor does not perform any large movements, but only extremely small rotational movements, such as through +/−30°, for example. If the rotor is in motion, in this context this means that, owing to the voltage generated in the first winding W1, considering a rotor revolution, for example, no or only a very low torque, such as +/−5% of a rated torque, for example, possibly in addition to a setpoint torque, is generated in the rotor. Thus, the energy transfer can be realized when the rotor is at a standstill and when the rotor is rotating. It is thus possible to prevent the vehicle from moving in an undesired manner during energy transfer, for example, if the 3-phase motor DM is coupled to the drive of the vehicle.

In this way, simple energy transfer between the two partial-energy on-board power systems TEB1, TEB2 is possible without galvanic coupling. Furthermore, no further component parts are required, as a result of which the energy transfer is enabled in a very favorable manner.

Owing to the galvanic decoupling, partial-energy on-board power systems above the shock-hazard protection limit of 60V can also be coupled inductively to partial-energy on-board power systems below the shock-hazard protection limit of 60V, which can primarily be used in electric vehicles or hybrid vehicles. Furthermore, a plurality of partial-energy on-board power systems with a rated voltage above the shock-hazard protection limit can also be coupled inductively to one another, which can likewise be used in electric and hybrid vehicles in order to implement low load, partial load or full load with differently designed actuators SG1, SG2 in a three-phase motor. As a result, the efficiency of the traction drive in the individual phases can be increased.

If only energy transfer in one direction is desired, it may also be possible to dispense with the switching elements of the second actuator SG2 and/or the switching elements of the first actuator SG1.

### LIST OF REFERENCE SYMBOLS

BN On-board power system
DM Three-phase motor
EE Individual element
EG Element group
TEB1 First partial-energy on-board power system
TEB2 Second partial-energy on-board power system
SV Control device
SG1 First actuator
SG2 Second actuator
W1 First winding
W2 Second winding
P1-P6 Phases

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating an on-board power system comprising a three-phase motor, having a stator and a rotor, wherein the stator has a first at least three-phase winding and a second at least three-phase winding, which are inductively coupled to one another, the device further having a first and a second electrical partial-energy on-board power system, a first actuator, which is electrically connected to the first at least three-phase winding and the first electrical partial-energy on-board power system, and a second actuator, which is electrically connected to the second at least three-phase winding and the second electrical partial-energy on-board power system, wherein the method comprises:
actuating, for energy transfer between the first and the second electrical partial-energy on-board power system, the first actuator such that a voltage is generated in the first at least three-phase winding, such that a voltage is induced in the second at least three-phase winding, a result of which is to transfer energy between the first and the second partial-energy on-board power system,
wherein the generated voltage in the first at least three-phase winding is an AC voltage with voltage vectors oriented to contribute to the fact that substantially no torque is generated in the rotor by the voltage generated for the energy transfer in the first winding.

2. The method as claimed in claim 1, wherein the voltage vectors of the generated voltage are oriented substantially perpendicular to a magnetic flux density of a magnetic excitation of the rotor.

3. The method as claimed in claim 1, wherein the voltage vectors of the generated voltage are oriented substantially parallel to a magnetic flux density of a magnetic excitation of the rotor.

4. The method as claimed in claim 1, wherein the first actuator has a circuit arrangement comprising at least three element groups connected in parallel and which each have at least two individual elements connected in series, wherein the each of the individual elements have a switching element and a diode connected in parallel, wherein the first at least three-phase winding is electrically connected to the circuit arrangement such that one of the at least three element groups is electrically connected between the individual elements to a phase of the first at least three-phase winding.

5. The method as claimed in claim 1, wherein, for the energy transfer between the second and the first electrical partial-energy on-board power system, the method comprises actuating the second actuator such that a voltage is generated in the second at least three-phase winding by the second actuator, such that a voltage is induced in the first at least three-phase winding, a result of which is that energy is transferred between the second and the first partial-energy on-board power system, wherein the voltage generated in the second at least three-phase winding is an AC voltage whose voltage vectors are oriented to contribute to the fact that substantially no torque is generated in the rotor by the voltage generated for the energy transfer in the second at least three-phase winding.

6. The method as claimed in claim 1, wherein the second actuator has a circuit arrangement comprising at least three element groups connected in parallel and which each have at least two individual elements connected in series, wherein the each of the individual elements have a switching element and a diode connected in parallel, wherein the second at least three-phase winding is electrically connected to the circuit arrangement such that one of the at least three element groups is electrically connected between the individual elements to a phase of the second at least three-phase winding.

7. A device for operating an on-board power system comprising:
a three-phase motor, having a stator and a rotor, wherein the stator has a first at least three-phase winding and a second at least three-phase winding, which are inductively coupled to one another;
a first and a second electrical partial-energy on-board power system;
a first actuator, which is electrically connected to the first at least three-phase winding and the first electrical partial-energy on-board power system;
a second actuator electrically connected to the second at least three-phase winding and the second electrical partial-energy on-board power system;
wherein, for energy transfer between the first and the second electrical partial-energy on-board power system, the first actuator is actuated to generate a voltage in the first at least three-phase winding, such that a voltage is induced in the second at least three-phase winding, a result of which is to transfer energy between the first and the second partial-energy on-board power system, and
wherein the generated voltage in the first at least three-phase winding is an AC voltage with voltage vectors oriented to contribute to the fact that substantially no torque is generated in the rotor by the voltage generated for the energy transfer in the first winding.

8. The device as claimed in claim 7, wherein the voltage vectors of the generated voltage are oriented substantially perpendicular to a magnetic flux density of a magnetic excitation of the rotor.

9. The device as claimed in claim 7, wherein the voltage vectors of the generated voltage are oriented substantially parallel to a magnetic flux density of a magnetic excitation of the rotor.

10. The device as claimed in claim 7, wherein the first actuator has a circuit arrangement comprising at least three element groups connected in parallel and which each have at least two individual elements connected in series, wherein the each of the individual elements have a switching element and a diode connected in parallel, wherein the first at least three-phase winding is electrically connected to the circuit arrangement such that one of the at least three element groups is electrically connected between the individual elements to a phase of the first at least three-phase winding.

11. The device as claimed in claim 7, wherein, for the energy transfer between the second and the first electrical partial-energy on-board power system, the second actuator is configured to be actuated to generate a voltage in the second at least three-phase winding, such that a voltage is induced in the first at least three-phase winding, a result of which is that energy is transferred between the second and the first partial-energy on-board power system, wherein the voltage generated in the second at least three-phase winding is an AC voltage whose voltage vectors are oriented to contribute to the fact that substantially no torque is generated in the rotor by the voltage generated for the energy transfer in the second at least three-phase winding.

12. The device as claimed in claim 7, wherein the second actuator has a circuit arrangement comprising at least three element groups connected in parallel and which each have at least two individual elements connected in series, wherein the each of the individual elements have a switching element and a diode connected in parallel, wherein the second at least three-phase winding is electrically connected to the circuit arrangement such that one of the at least three element groups is electrically connected between the individual elements to a phase of the second at least three-phase winding
